(19) United States
(12) Patent Application Publication
(10) Pub. No.: US 2023/0196175 A1
(43) Pub. Date: Jun. 22, 2023

(54) CENTRALIZING PROVISION OF QUANTUM CORE SERVICES (QCSs)

(71) Applicant: Red Hat, Inc., Raleigh, NC (US)

(72) Inventors: Leigh Griffin, Waterford (IE); Stephen Coady, Waterford (IE)

(21) Appl. No.: 17/557,890

(22) Filed: Dec. 21, 2021

(51) Int. Cl. G06N 10/80; G06N 10/20; G06F 9/48

(52) U.S. Cl. CPC G06N 10/80; G06N 10/20; G06F 9/4881

(57) ABSTRACT

Centralizing provision of quantum core services (QCSs) is disclosed herein. In one example, a first processor device of a first quantum computing device is to receive, from a second quantum computing device, QCS metadata for a second QCS of the second quantum computing device. The first processor device is further to instruct the second quantum computing device to forward a service request directed to the second QCS of the second quantum computing device to the first quantum computing device. The first processor device initializes a first QCS of the first quantum computing device using the QCS metadata. The first processor device subsequently receives the service request from the second quantum computing device, and services the service request using the first QCS.

### BACKGROUND

Quantum computing involves the use of quantum bits, referred to herein as “qubits,” which have characteristics that differ from those of classical (i.e., non-quantum) bits used in classical computing. Qubits may be employed by quantum services that are executed by quantum computing devices. Quantum computing devices also provide quantum core services (QCSs) to manage and facilitate the use of qubits and the execution of quantum services. As quantum computing continues to increase in popularity and become more commonplace, an ability to efficiently provide QCS functionality in multi-device computing systems will be desirable.

### SUMMARY

The examples disclosed herein centralize provision of quantum core services (QCSs) in quantum computer systems. In one example, a QCS manager service, executing on a first quantum computing device, provides a mechanism by which the first quantum computing device is selected as a QCS manager for multiple quantum computing devices. The first quantum computing device initializes a first QCS with QCS metadata from a second QCS of a second quantum computing device, and instructs the second quantum computing device to forward a service request directed to the second QCS to the first quantum computing device. The first quantum computing device then receives the service request, and services the service request using the first QCS.

In another example, a method for centralizing provision of QCSs is disclosed. The method comprises receiving, by a first quantum computing device from a second quantum computing device, QCS metadata for a second QCS of the second quantum computing device. The method further comprises configuring the second quantum computing device to forward a service request directed to the second QCS of the second quantum computing device to the first quantum computing device. The method also comprises initializing a first QCS of the first quantum computing device using the QCS metadata. The method additionally comprises receiving, by the first quantum computing device, the service request from the second quantum computing device. The method further comprises servicing, using the first QCS, the service request.

In another example, a quantum computing system for centralizing provision of QCSs is disclosed. The quantum computing system includes a first quantum computing device that comprises a first system memory, and a first processor device communicatively coupled to the first system memory. The first processor device is to receive, from a second quantum computing device of the quantum computing system, QCS metadata for a second QCS of the second quantum computing device. The first processor device is further to configure the second quantum computing device to forward a service request directed to the second QCS of the second quantum computing device to the first quantum computing device. The first processor device is also to initialize a first QCS of the first quantum computing device using the QCS metadata. The first processor device is additionally to receive the service request from the second quantum computing device. The first processor device is further to service, using the first QCS, the service request.

In another example, a non-transitory computer-readable medium for centralizing provision of QCSs is disclosed. The non-transitory computer-readable medium stores thereon computer-executable instructions that, when executed, cause one or more processor devices to receive, by a first quantum computing device from a second quantum computing device, QCS metadata for a second QCS of the second quantum computing device. The computer-executable instructions further cause the one or more processor devices to configure the second quantum computing device to forward a service request directed to the second QCS of the second quantum computing device to the first quantum computing device. The computer-executable instructions also cause the one or more processor devices to initialize a first QCS of the first quantum computing device using the QCS metadata. The computer-executable instructions additionally cause the one or more processor devices to receive the service request from the second quantum computing device. The computer-executable instructions further cause the one or more processor devices to service, using the first QCS, the service request.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of a quantum computing system in which examples may be practiced;

FIGS. 2A-2C are flowcharts illustrating operations performed by the computing system of FIG. 1 for centralizing provision of quantum core services (QCSs), according to one example;

FIG. 3 is a simpler block diagram of the computing system of FIG. 1 for centralizing provision of QCSs, according to one example;

FIG. 4 is a flowchart of a simplified method for centralizing provision of QCSs by the quantum computing device of FIG. 3, according to one example; and

FIG. 5 is a block diagram of a quantum computing device suitable for implementing examples.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples are not limited to any particular sequence of steps. The use herein of ordinals in conjunction with an element is solely for distinguishing what might otherwise be similar or identical labels, such as “first quantum computing device” and “second quantum computing device,” and does not imply a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B.

Quantum computing involves the use of quantum bits, referred to herein as “qubits,” each of which has properties (such as superposition and entanglement) that differ from those of classical (i.e., non-quantum) bits used in classical computing. Qubits may be employed by quantum services that are executed by quantum computing devices. Quantum computing devices also execute quantum core services (QCSs), which are operating-system-level services that provide functionality for managing and facilitating the use of qubits and the execution of quantum services. These QCSs may include, as non-limiting examples, a qubit registry, a quantum task manager, and/or a quantum service scheduler, examples of which are discussed in greater detail below.

A quantum computing system may include multiple quantum computing devices, each of which executes its own local instance of one or more QCSs. In some examples, the multiple quantum computing devices may be configured to communicate and interoperate as a unified quantum machine to enable more complex quantum operations to be performed. As the use of multiple quantum computing devices in this manner becomes more prevalent, it may be desirable to provide a single mechanism for providing centralized QCS functionality for multiple quantum computing devices in the quantum computing system.

In this regard, examples disclosed herein implement a QCS manager (QCSM) service for centralizing provision of QCSs. In one example, a QCSM service executes on each quantum computing device of a plurality of quantum computing devices of a quantum computing system. Each instance of the QCSM service is configured to communicate with other instances, as well as with one or more local QCSs (e.g., a qubit registry, a quantum task manager, and/or a quantum scheduler, as non-limiting examples) of the QCMS service's host quantum computing device. The QCSM services each are further configured to coordinate communications with other instances, other quantum computing devices, and/or QCSs of the other quantum computing devices so as to enable a local QCS to provide functionality to other quantum computing devices within the quantum computing system.

In exemplary operation, the QCSM service of a first quantum computing device that has been selected as a QCS manager for a quantum computing system receives QCS metadata for a second QCS of a second quantum computing device. As used herein, the term “QCS manager” and derivatives thereof refer to a quantum computing device, among a plurality of quantum computing devices of a quantum computing system, that is configured to provide functionality of a QCS for other quantum computing devices among the plurality of quantum computing devices. The QCS metadata comprises data representing a current state of the second QCS of the second quantum computing device, and thus may include, as non-limiting examples, data relating to quantum services on the second quantum computing device, quantum services scheduled to execute on the second quantum computing device, qubits in use on the second quantum computing device, qubits available for allocation on the second quantum computing device, allocation of qubits to quantum services, and the like.

According to some examples, the first quantum computing device may be selected as QCS manager based on one or more of a functionality of the first quantum computing device, a system load of the first quantum computing device, a geographical location of the first quantum computing device, or an environmental attribute of the first quantum computing device. In some examples, the QCSM service of the first quantum computing device itself may independently select the first quantum computing device as QCS manager, or the selection may be made by or in cooperation with one or more other QCSM services of a corresponding one or more other quantum computing devices.

The QCSM service of the first quantum computing device then configures the second quantum computing device to forward a service request directed to the second QCS of the second quantum computing device to the first quantum computing device. As used here, the term “service request” and derivatives thereof refer to a local communication sent from a quantum service to a QCS to request or initiate some functionality provided by the QCS. For instance, in examples where the QCS is a qubit registry, a service request may comprise a request to allocate or deallocate a qubit, while in examples in which the QCS is a quantum task manager, a service request may comprise a request to suspend or terminate a quantum service. The QCSM service according to some examples may configure the second quantum computing device to forward the service request by configuring the second QCS itself to forward the service request to the first quantum computing device. In examples in which quantum services executing on the second quantum computing device access the second QCS using an alias that points to the second QCS, the QCSM service may configure the second quantum computing device to forward the service request by configuring the alias to point to the first quantum computing device instead.

Some examples may provide that the QCSM service of the first quantum computing device causes the second QCS of the second quantum computing device to enter an inactive state (e.g., by issuing a shutdown or suspend request to the QCSM service of the second quantum computing device, or directly to the second QCS). In this manner, processing resources that would normally be consumed by the second QCS may be conserved by the second quantum computing device while the first quantum computing device is acting as the QCS manager. The QCSM service in some examples may update a service definition for a quantum service of the second quantum computing device, so as to cause subsequent instances of the quantum service that is defined by the service definition to direct the service request to the first quantum computing device. The service definition may comprise, as a non-limiting example, a Quantum Assembly (QASM) file.

The QCSM service of the first quantum computing device next initializes a first QCS of the first quantum computing device using the QCS metadata. This operation prepares the first QCS to assume the functionality of the second QCS. The first quantum computing device then receives the service request from the second quantum computing device (e.g., via the QCSM service or directly by the first QCS, as non-limiting examples), and services the service request using the first QCS.

In examples in which the QCSM service of the first quantum computing device causes the second QCS of the second quantum computing device to enter an inactive state, the QCSM service of the second quantum computing device may subsequently monitor connectivity with the first quantum computing device. If a loss of connectivity with the first quantum computing device is detected (i.e., resulting in a loss of network access to the QCSM service and the first QCS of the first quantum computing device), the QCSM service of the second quantum computing device may restart the second QCS of the second quantum computing device. This ensures that the second QCS can resume servicing requests from local quantum services without interruption to the execution of the local quantum services.

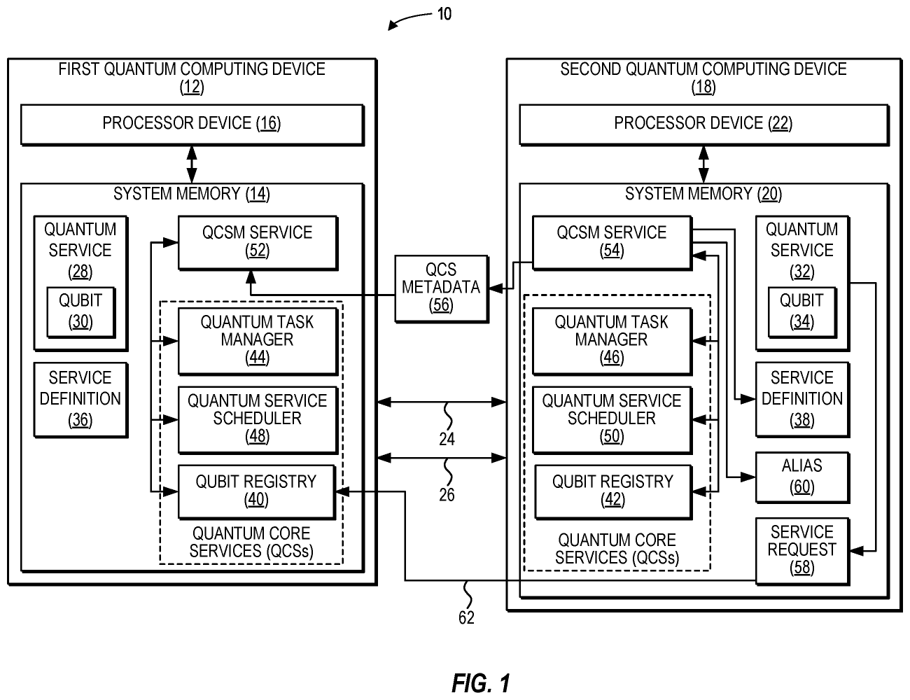

FIG. 1 is a block diagram of a quantum computing system 10 according to one example. The quantum computing system 10 includes a first quantum computing device 12 that comprises a system memory 14 and a processor device 16, and further includes a second quantum computing device 18 that comprises a system memory 20 and a processor device 22. The first quantum computing device 12 and the second quantum computing device 18 in the example of FIG. 1 are communicatively coupled via a classical communications link 24, which may comprise a private network or a public network such as the internet. The first quantum computing device 12 and the second quantum computing device 18 are also communicatively coupled to each other and/or to other quantum computing devices (not shown) via a quantum channel 26 over which qubits may be transmitted. It is to be understood that the quantum computing system 10, according to some examples, may include more or fewer quantum computing devices and/or classical computing devices than illustrated in FIG. 1. Additionally, the first quantum computing device 12 and/or the second quantum computing device 18 in some examples may include constituent elements in addition to those illustrated in FIG. 1.

The first quantum computing device 12 and the second quantum computing device 18 in the example of FIG. 1 operate in quantum environments, but are each capable of operating using classical computing principles or quantum computing principles. When using quantum computing principles, the first quantum computing device 12 and the second quantum computing device 18 perform computations that utilize quantum-mechanical phenomena, such as superposition and/or entanglement states. The first quantum computing device 12 and the second quantum computing device 18 may operate under certain environmental conditions, such as at or near zero degrees (0°) Kelvin. When using classical computing principles, the first quantum computing device 12 and the second quantum computing device 18 utilize binary digits that have a value of either zero (0) or one (1).

In the example of FIG. 1, the first quantum computing device 12 executes a quantum service 28, which comprises a process that employs one or more qubits such as a qubit 30 to perform quantum operations. Similarly, the second quantum computing device 18 executes a quantum service 32 that employs a qubit 34. The quantum service 28 and the quantum service 32 are defined by a service definition 36 and a service definition 38, respectively, each of which comprises quantum programming instructions for allocating and manipulating qubits to achieve a desired functionality. In some examples, the service definition 36 and/or the service definition 38 may comprise a QASM file.

To maintain information for qubits such as the qubit 30 and the qubit 34, the first quantum computing device 12 and the second quantum computing device 18 provide respective qubit registries 40 and 42, each of which comprises a plurality of qubit registry entries (not shown) that each correspond to a qubit. The qubit registry 40 and the qubit registry 42 maintain and provide access to data relating to the qubits implemented by the corresponding quantum computing devices 12 and 18, including a count of the total number of qubits implemented by the quantum computing devices 12 and 18, and a count of the number of available qubits that are currently available for allocation, as non-limiting examples. Each of the qubit registry entries of the qubit registry 40 and the qubit registry 42 also stores qubit metadata for a corresponding qubit. The qubit metadata may include, as non-limiting examples, an identifier of the corresponding qubit, an availability indicator that indicates whether the corresponding qubit is available for use or is in use by a specific quantum service, an identifier of a quantum service that is associated with the corresponding qubit or to which the corresponding qubit is allocated, and/or an entanglement indicator that indicates whether the corresponding qubit is in an entangled state.

Execution of quantum services such as the quantum service 28 and the quantum service 32 is facilitated by quantum task managers 44 and 46 and quantum service schedulers 48 and 50, each of which operates in a manner analogous to their conventional classical counterparts. Thus, the quantum task manager 44 of the first quantum computing device 12 and the quantum task manager 46 of the second quantum computing device 18 handle operations for creating, monitoring, and terminating quantum services, while the quantum service scheduler 48 of the first quantum computing device 12 and the quantum service scheduler 50 of the second quantum computing device 18 control the scheduling of quantum services for execution by processor devices 16 and 22, and the allocation of processing resources to executing quantum services. The functionality of the quantum task managers 44 and 46 and the quantum service schedulers 48 and 50 may be made accessible to other services and processes (e.g., via defined application programming interfaces (APIs), as a non-limiting example).

Each of the quantum task managers 44 and 46, the quantum service schedulers 48 and 50, and the qubit registries 40 and 42 is an example of a QCS, which comprise operating-system-level services that enable functionality for managing and facilitating the use of qubits and the execution of quantum services. Accordingly, each may be generally referred to herein as a QCS (e.g., the qubit registry 40 may be referred to as a “QCS 40,” while the qubit registry 42 may be referred to herein as a “QCS 42”).

In quantum computing systems such as the quantum computing system 10, the first quantum computing device 12 and the second quantum computing device 18 may be configured to communicate and interoperate as a unified quantum machine to enable more complex quantum operations to be performed. In such configurations, it may be desirable to provide a single mechanism for providing centralized QCS functionality for one or more of the QCSs provided by the first quantum computing device 12 and the second quantum computing device 18.

In this regard, examples disclosed herein implement a QCSM service 52 and a QCSM service 54 for centralizing provision of QCSs. In the example of FIG. 1, the QCSM service 52 is executed by the first quantum computing device 12, while the QCSM service 54 is executed by the second quantum computing device 18. The QCSM service 52 and the QCSM service 54 are configured to communicate with each other, as well as with local QCSs. Thus, for example, the QCSM service 52 is configured to communicate with the quantum task manager 44, the quantum service scheduler 48, and the qubit registry 40, while the QCSM service 54 is configured to communicate with the quantum task manager 46, the quantum service scheduler 50, and the qubit registry 42. The QCSM services 52 and 54 each may be further configured to coordinate communications with other quantum computing devices and/or QCSs of the other quantum computing devices, so as to enable a local QCS to provide functionality to other quantum computing devices within the quantum computing system. For instance, the QCSM service 52 may be configured to communicate with the second quantum computing device 18 and/or directly with a QCS of the second quantum computing device 18, such as the qubit registry 42.

In exemplary operation, one of the QCSM services, such as the QCSM service 52 of the first quantum computing device 12, may be selected as a QCS manager for the quantum computing system 10. In some examples, the selection of the QCSM service 52 as the QCS manager may be based on a functionality of the first quantum computing device 12, a system load of the first quantum computing device 12, a geographical location of the first quantum computing device 12, or an environmental attribute of the first quantum computing device 12. Thus, for instance, if the first quantum computing device 12 provides some unique or in-demand functionality, is experiencing lower processor load, and/or is experiencing favorable environmental attributes such as lower temperatures relative to the second quantum computing device 18, the QCSM service 52 of the first quantum computing device 12 may be selected as the QCS manager for the quantum computing system 10. As the QCS manager, the QCSM service 52 and one or more of the QCSs provided by the first quantum computing device 12 may provide functionality to quantum services of the second quantum computing device 18 in place of the QCSs of the second quantum computing device 18. In some examples, the QCSM service 52 of the first quantum computing device 12 itself may independently select the QCS manager based on information available to it, or the selection may be made by or in cooperation with the QCSM service 54 of the second quantum computing device 18.

The QCSM service 52 of the first quantum computing device 12 may be selected as the QCS manager for only one QCS provided by the first quantum computing device 12 and the second quantum computing device 18, or for more than one of the QCSs provided by the first quantum computing device 12 and the second quantum computing device 18. According to some examples, the QCSM service 52 of the first quantum computing device 12 and the QCSM service 54 of the second quantum computing device 18 each may serve as a QCS manager for different QCSs at the same time. For purposes of illustration, it is assumed that in FIG. 1 the QCSM service 52 is selected as the QCS manager for qubit registry functionality in the quantum computing system 10. Thus, the qubit registry 40 of the first quantum computing device 12 is referred to herein as the “first QCS 40,” while the qubit registry 42 of the second quantum computing device 18 is referred to herein as the “second QCS 42.”

The QCSM service 52 receives QCS metadata 56 for the second QCS 42 from the second quantum computing device 18 (e.g., from the QCSM service 54). The QCS metadata 56 comprises data that represents a current state of the second QCS 42 (i.e., the qubit registry 42), and thus may include, as non-limiting examples, data relating to qubits in use on the second quantum computing device 18, qubits available for allocation on the second quantum computing device 18, allocation of qubits to quantum services, and the like.

The QCSM service 52 configures the second quantum computing device 18 to forward a service request 58 that is directed to the second QCS 42 to the first quantum computing device 12 (e.g., to the QCSM service 52 or directly to the first QCS 40). As used here, the term “service request” and derivatives thereof refer to a local communication sent from a quantum service, such as the quantum service 32, to a QCS such as the second QCS 42 to request or initiate some functionality provided by the second QCS 42. In the example of FIG. 1 where the second QCS 42 is the qubit registry 42, the service request 58 may comprise, for instance, a request to allocate or deallocate a qubit.

Configuring the second quantum computing device 18 to forward the service request 58 may be accomplished by the QCSM service 52 transmitting an instruction or request to the QCSM service 54 or directly to the second QCS 42 (e.g., using an API). In some examples, the QCSM service 52 may configure the second quantum computing device 18 to forward the service request 58 by configuring the second QCS 42 itself to forward the service request 58 to the first quantum computing device 12. According to some examples, the second quantum computing device 18 may be configured to enable quantum services such as the quantum service 32 to access the second QCS 42 using an alias 60 that points to the second QCS 42. In such examples, the QCSM service 52 may configure the second quantum computing device 18 to forward the service request 58 by configuring the alias 60 to point to the first quantum computing device 12 instead.

The QCSM service 52 of the first quantum computing device 12 in some examples may cause the second QCS 42 of the second quantum computing device 18 to enter an inactive state. For instance, the QCSM service 52 may issue a shutdown or suspend request to the QCSM service 54 or directly to the second QCS 42. By causing the second QCS 42 to enter an inactive state, the QCSM service 52 enables processing resources that would normally be consumed by the second QCS 42 to conserved by the second quantum computing device 18 while the first quantum computing device 12 is acting as the QCS manager. According to some examples, the QCSM service 52 may update a service definition for a quantum service of the second quantum computing device 18 (such as the service definition 38 for the quantum service 32). This causes subsequent instances of the quantum service 32 defined by the service definition 38 to direct the service request 58 to the first quantum computing device 12.

The QCSM service 52 of the first quantum computing device 12 then initializes the first QCS 40 using the QCS metadata 56, which prepares the first QCS 40 to assume the functionality of the second QCS 42 by recreating a state of the second QCS 42 in the first QCS 40. The first quantum computing device 12 subsequently receives the service request 58 forwarded by the second quantum computing device 18 as indicated by arrow 62, and services the service request 58 using the first QCS 40 (i.e., by performing the functionality requested by the service request 58 in place of the second QCS 42). In the example of FIG. 1, the service request 58 is shown as being forwarded directly to the first QCS 40, but it is to be understood that, in some examples, the service request 58 may be routed to the first QCS 40 via the QCSM service 52.

In examples in which the QCSM service 52 causes the second QCS 42 to enter an inactive state, the QCSM service 54 of the second quantum computing device 18 may subsequently monitor connectivity between the second quantum computing device 18 and the first quantum computing device 12. If a loss of connectivity with the first quantum computing device 12 is detected, such that network access to the QCSM service 52 and the first QCS 40 is lost, the QCSM service 54 of the second quantum computing device 18 may restart the second QCS 42, and may take steps to redirect service requests such as the service request 58 back to the second QCS 42. In this manner, the second QCS 42 can resume servicing requests from local quantum services without interruption to the execution of the local quantum services.

It is to be understood that, because the QCSM service 52 and the QCSM service 54 are components of the first quantum computing device 12 and the second quantum computing device 18, respectively, functionality implemented by the QCSM service 52 and/or the QCSM service 54 may be attributed to the quantum computing system 10 generally. Moreover, in examples where the QCSM service 52 and the QCSM service 54 comprise software instructions that program the processor device 16 and the processor device 22, respectively, to carry out functionality discussed herein, functionality implemented by the QCSM service 52 and the QCSM service 54 may be attributed herein to the processor device 16 and the processor device 22, respectively.

It is to be further understood that while, for purposes of illustration only, the QCSM service 52 and the QCSM service 54 are each depicted as a single component, the functionality implemented by the QCSM service 52 and the QCSM service 54 may be implemented in any number of components, and the examples discussed herein are not limited to any particular number of components. Moreover, it is noted that while, for purposes of illustration and simplicity, the examples are illustrated as being implemented by a processor device set that includes a single processor device on a single computing device, in other environments, such as a distributed and/or clustered environment, the examples may be implemented on a computer system that includes a processor device set that includes a plurality of processor devices of a plurality of different computing devices, and functionality of the examples may be implemented on different processor devices of different computing devices. Thus, irrespective of the implementation, the examples may be implemented on a computer system that includes a processor device set made up of one or more processor devices of one or more computing devices.

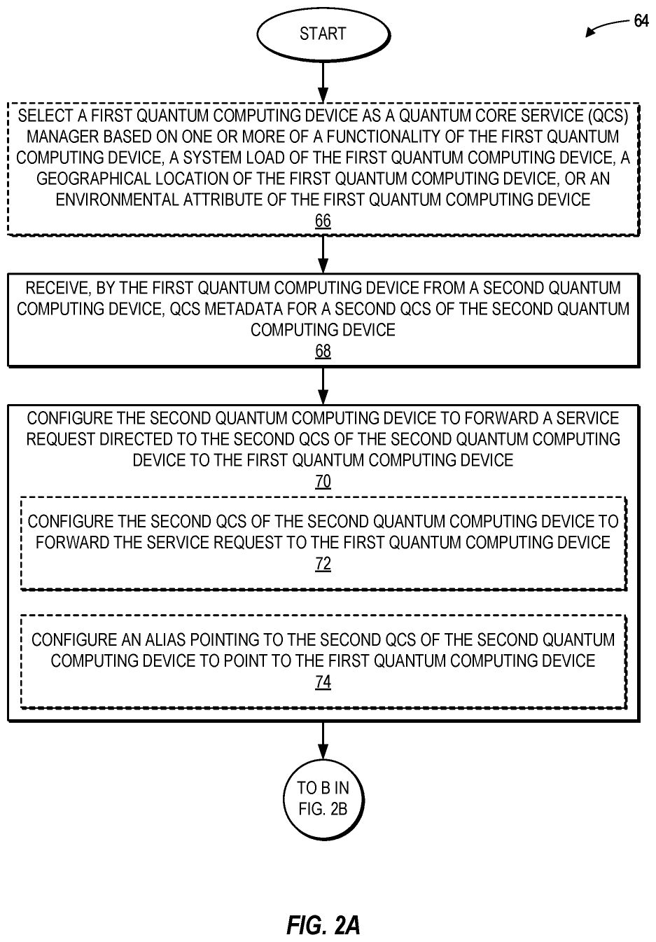

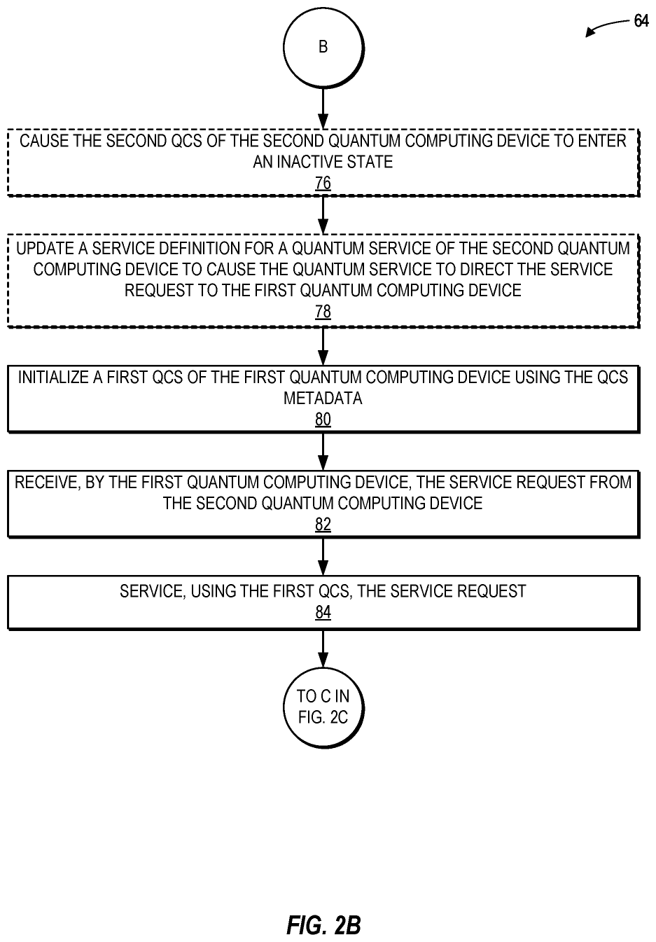

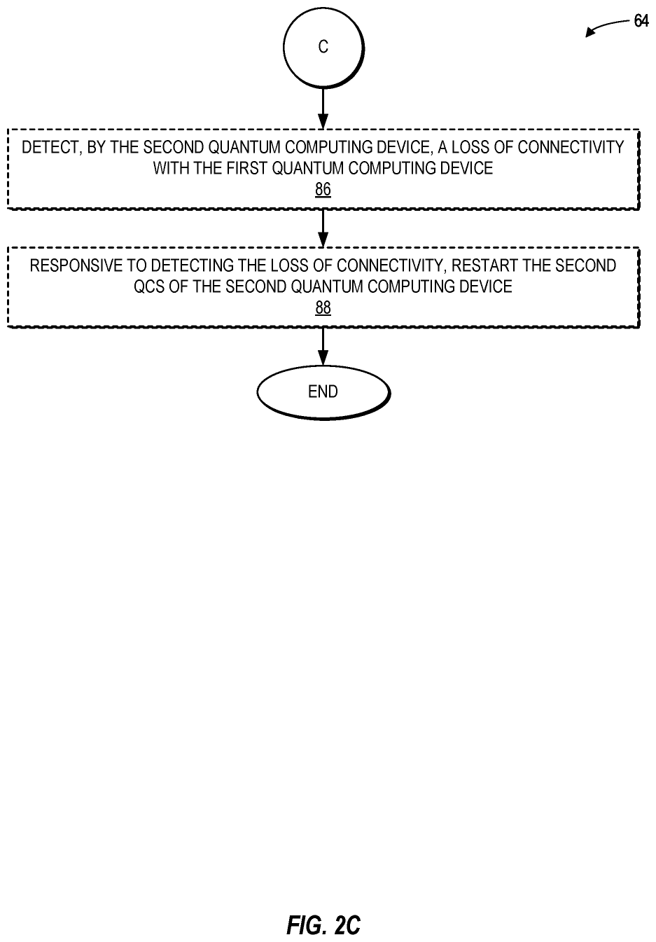

To illustrate exemplary operations performed by the quantum computing system 10 of FIG. 1 for centralizing provision of QCSs according to one example, FIGS. 2A-2C provide a flowchart 64. Elements of FIG. 1 are referenced in describing FIGS. 2A-2C for the sake of clarity. It is to be understood that, in some examples, some operations illustrated in FIGS. 2A-2C may be performed in an order other than illustrated herein, and/or may be omitted.

In FIG. 2A, operations in some examples may begin with the first processor device 16 of the first quantum computing device 12 (e.g., by executing the QCSM service 52 of FIG. 1) selecting the first quantum computing device 12 as QCS manager based on one or more of a functionality of the first quantum computing device 12, a system load of the first quantum computing device 12, a geographical location of the first quantum computing device 12, or an environmental attribute of the first quantum computing device 12 (block 66). The QCSM service 52 itself may independently select the first quantum computing device 12 as QCS manager, or the selection may be made by or in cooperation with another QCS manager such as the QCSM service 54 of the second quantum computing device 18.

The QCSM service 52 subsequently receives, from the second quantum computing device 18, QCS metadata (e.g., the QCS metadata 56 of FIG. 1) for a second QCS (e.g., the qubit registry 42 of FIG. 1, also referred to herein as “the second QCS 42”) of the second quantum computing device 18 (block 68). The QCSM service 52 then configures the second quantum computing device 18 to forward a service request directed to the second QCS 42 of the second quantum computing device 18 (e.g., the service request 58 of FIG. 1) to the first quantum computing device 12 (block 70). Some examples may provide that the operations of block 70 for configuring the second quantum computing device 18 comprise configuring the second QCS 42 of the second quantum computing device 18 to forward the service request 58 to the first quantum computing device 12 (block 72). According to some examples (e.g., examples in which the quantum service 32 accesses the second QCS 42 via the alias 60), the operations of block 70 for configuring the second quantum computing device 18 may comprise configuring the alias 60 pointing to the second QCS 42 of the second quantum computing device 18 to point to the first quantum computing device 12 (block 74). Operations in some examples then continue at block 76 of FIG. 2B.

Referring now to FIG. 2B, in some examples, the QCSM service 52 may cause the second QCS 42 of the second quantum computing device 18 to enter an inactive state (block 76). This may be accomplished in some examples by the QCSM service 52 transmitting a shutdown or suspend request to the QCSM service 54, or directly to the second QCS 42. Some examples may provide that the QCSM service 52 updates a service definition for a quantum service of the second quantum computing device 18 (e.g., the service definition 38 for the quantum service 32 of FIG. 1) to cause the quantum service 32 to direct the service request 58 to the first quantum computing device 12 (block 78). The QCSM service 52 then initializes a first QCS (e.g., the qubit registry 40 of FIG. 1, also referred to herein as “the first QCS 40”) of the first quantum computing device 12 using the QCS metadata 56 (block 80). The QCSM service 52 receives the service request 58 from the second quantum computing device 18 (block 82). The first QCS 40 then services the service request 58 (block 84). Operations in some examples may continue at block 86 of FIG. 2C.

Turning now to FIG. 2C, some examples may provide that the processor device 22 of the second quantum computing device 18 (e.g., by executing the QCSM service 54) may detect a loss of connectivity with the first quantum computing device 12 (block 86). In response to detecting the loss of connectivity, the QCSM service 54 may restart the second QCS 42 of the second quantum computing device 18 (block 88).

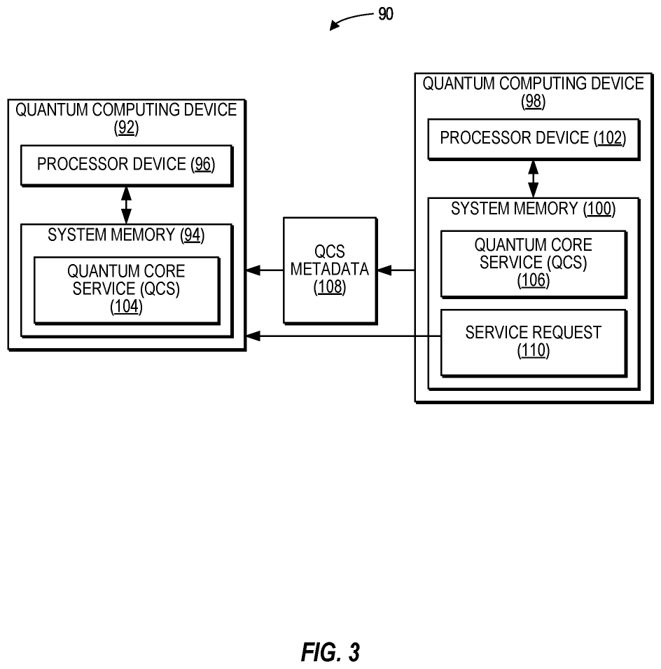

FIG. 3 is a simpler block diagram of the quantum computing system 10 of FIG. 1 for centralizing provision of QCSs, according to one example. In the example of FIG. 3, a quantum computing system 90 includes a first quantum computing device 92 that comprises a first system memory 94 and a first processor device 96 communicatively coupled to the first system memory 94. The quantum computing system 90 also includes a second quantum computing device 98 that comprises a second system memory 100 and a second processor device 102 communicatively coupled to the second system memory 100. The first quantum computing device 92 and the second quantum computing device 98 execute a first QCS 104 and a second QCS 106, respectively.

In exemplary operation, the first processor device 96 of the first quantum computing device 92 receives QCS metadata 108 for the second QCS 106 from the second quantum computing device 98. The first processor device 96 configures the second quantum computing device 98 to forward a service request 110 that is directed to the second QCS 106 to the first quantum computing device 92. The first processor device 96 then initializes the first QCS 104 using the QCS metadata 108, which prepares the first QCS 104 to assume the functionality of the second QCS 106. The first processor device 96 subsequently receives the service request 110 forwarded by the second quantum computing device 98, and services the service request 110 using the first QCS 104.

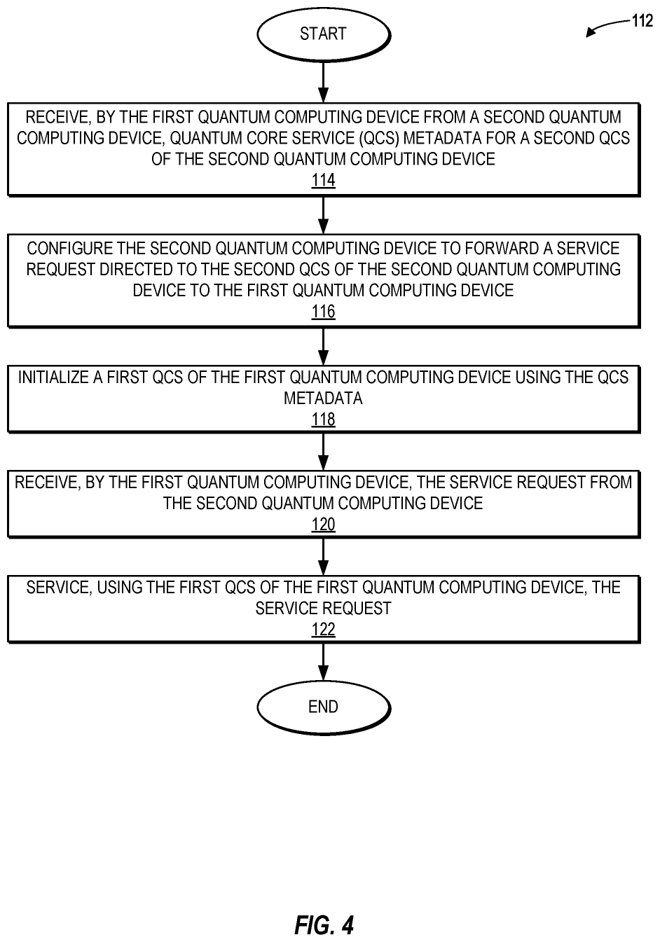

FIG. 4 provides a flowchart 112 to illustrate a simplified method for centralizing provision of QCSs by the quantum computing system 90 of FIG. 3 according to one example. For the sake of clarity, elements of FIG. 3 are referenced in describing FIG. 4. Operations in FIG. 4 begin with the first processor device 96 of the first quantum computing device 92 receiving, from the second quantum computing device 98, the QCS metadata 108 for the second QCS 106 of the second quantum computing device 98 (block 114). The first processor device 96 then configures the second quantum computing device 98 to forward the service request 110 directed to the second QCS 106 of the second quantum computing device 98 to the first quantum computing device 92 (block 116). The first processor device 96 initializes the first QCS 104 of the first quantum computing device 92 using the QCS metadata 108 (block 118). The first processor device 96 next receives the service request 110 from the second quantum computing device 98 (block 120). The first processor device 96 then services, using the first QCS 104, the service request 110 (block 122).

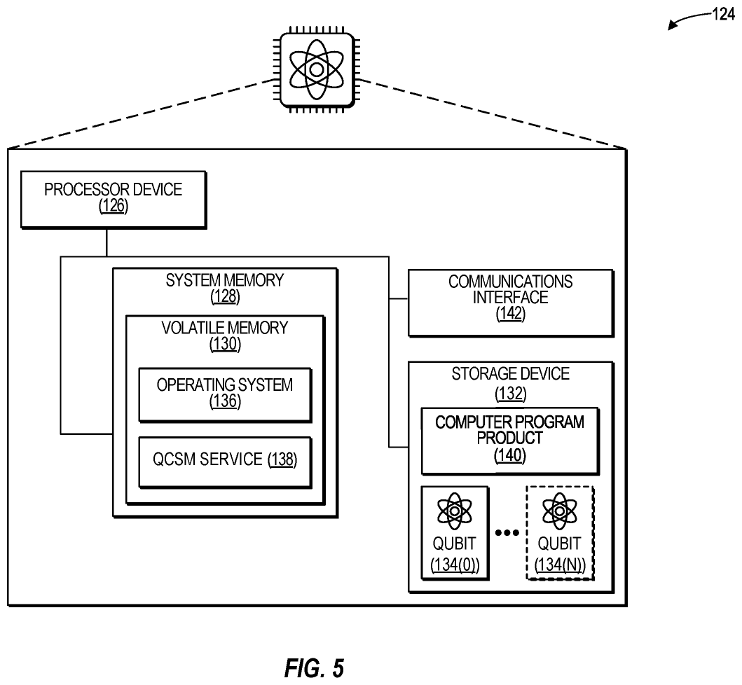

FIG. 5 is a block diagram of a quantum computing device 124, such as the first quantum computing device 12 of FIG. 1, suitable for implementing examples according to one example. The quantum computing device 124 may comprise any suitable quantum computing device or devices. The quantum computing device 124 can operate using classical computing principles or quantum computing principles. When using quantum computing principles, the quantum computing device 124 performs computations that utilize quantum-mechanical phenomena, such as superposition and entanglement. The quantum computing device 124 may operate under certain environmental conditions, such as at or near zero degrees (0°) Kelvin. When using classical computing principles, the quantum computing device 124 utilizes binary digits that have a value of either zero (0) or one (1).

The quantum computing device 124 includes a processor device 126 and a system memory 128. The processor device 126 can be any commercially available or proprietary processor suitable for operating in a quantum environment. The system memory 128 may include volatile memory 130 (e.g., random-access memory (RAM)). The quantum computing device 124 may further include or be coupled to a non-transitory computer-readable medium such as a storage device 132. The storage device 132 and other drives associated with computer-readable media and computer-usable media may provide non-volatile storage of data, data structures, computer-executable instructions, and the like. The storage device may also provide functionality for storing one or more qubits 134(0)-134(N).

A number of modules can be stored in the storage device 132 and in the volatile memory 130, including an operating system 136 and one or more modules, such as a QCSM service 138. All or a portion of the examples may be implemented as a computer program product 140 stored on a transitory or non-transitory computer-usable or computer-readable medium, such as the storage device 132, which includes complex programming instructions, such as complex computer-readable program code, to cause the processor device 126 to carry out the steps described herein. Thus, the computer-readable program code can comprise computer-executable instructions for implementing the functionality of the examples described herein when executed on the processor device 126.

An operator may also be able to enter one or more configuration commands through a keyboard (not illustrated), a pointing device such as a mouse (not illustrated), or a touch-sensitive surface such as a display device (not illustrated). The quantum computing device 124 may also include a communications interface 142 suitable for communicating with other quantum computing systems, including, in some implementations, classical computing devices.

Individuals will recognize improvements and modifications to the preferred examples of the disclosure. All such improvements and modifications are considered within the scope of the concepts disclosed herein and the claims that follow.

What is claimed is:

1. A method, comprising:
receiving, by a first quantum computing device from a second quantum computing device, quantum core service (QCS) metadata for a second QCS of the second quantum computing device;
configuring the second quantum computing device to forward a service request directed to the second QCS of the second quantum computing device to the first quantum computing device;
initializing a first QCS of the first quantum computing device using the QCS metadata;
receiving, by the first quantum computing device, the service request from the second quantum computing device; and
servicing, using the first QCS, the service request.

2. The method of claim 1, further comprising causing the second QCS of the second quantum computing device to enter an inactive state.

3. The method of claim 2, further comprising:
detecting, by the second quantum computing device, a loss of connectivity with the first quantum computing device; and
responsive to detecting the loss of connectivity, restarting the second QCS of the second quantum computing device.

4. The method of claim 1, further comprising updating a service definition for a quantum service of the second quantum computing device to cause the quantum service to direct the service request to the first quantum computing device.

5. The method of claim 4, wherein the service definition comprises a Quantum Assembly (QASM) file.

6. The method of claim 1, further comprising selecting the first quantum computing device as QCS manager based on one or more of a functionality of the first quantum computing device, a system load of the first quantum computing device, a geographical location of the first quantum computing device, or an environmental attribute of the first quantum computing device.

7. The method of claim 1, wherein configuring the second quantum computing device comprises configuring the second QCS of the second quantum computing device to forward the service request to the first quantum computing device.

8. The method of claim 1, wherein configuring the second quantum computing device comprises configuring an alias pointing to the second QCS of the second quantum computing device to point to the first quantum computing device.

9. The method of claim 1, wherein the first QCS and the second QCS comprise one of a qubit registry, a quantum task manager, or a quantum scheduler.

10. A quantum computing system, comprising a first quantum computing device comprising:
a first system memory; and
a first processor device communicatively coupled to the first system memory, the first processor device to:
receive, from a second quantum computing device of the quantum computing system, quantum core service (QCS) metadata for a second QCS of the second quantum computing device;
configure the second quantum computing device to forward a service request directed to the second QCS of the second quantum computing device to the first quantum computing device;
initialize a first QCS of the first quantum computing device using the QCS metadata;
receive the service request from the second quantum computing device; and
service, using the first QCS, the service request.

11. The quantum computing system of claim 10, wherein the first processor device is further to cause the second QCS of the second quantum computing device to enter an inactive state.

12. The quantum computing system of claim 11, further comprising the second quantum computing device comprising:
a second system memory; and
a second processor device communicatively coupled to the second system memory, the second processor device to:
detect a loss of connectivity with the first quantum computing device; and
responsive to detecting the loss of connectivity, restart the second QCS of the second quantum computing device.

13. The quantum computing system of claim 10, wherein the first processor device is further to update a service definition for a quantum service of the second quantum computing device to cause the quantum service to direct the service request to the first quantum computing device.

14. The quantum computing system of claim 13, wherein the service definition comprises a Quantum Assembly (QASM) file.

15. The quantum computing system of claim 10, wherein the first processor device is further to select the first quantum computing device as QCS manager based on one or more of a functionality of the first quantum computing device, a system load of the first quantum computing device, a geographical location of the first quantum computing device, or an environmental attribute of the first quantum computing device.

16. The quantum computing system of claim 10, wherein to configure the second quantum computing device is to configure the second QCS of the second quantum computing device to forward the service request to the first quantum computing device.

17. The quantum computing system of claim 10, wherein to configure the second quantum computing device is to configure an alias pointing to the second QCS of the second quantum computing device to point to the first quantum computing device.

18. The quantum computing system of claim 10, wherein the first QCS and the second QCS comprise one of a qubit registry, a quantum task manager, or a quantum scheduler.

19. A non-transitory computer-readable medium having stored thereon computer-executable instructions that, when executed, cause one or more processor devices to:
receive, by a first quantum computing device from a second quantum computing device, quantum core service (QCS) metadata for a second QCS of the second quantum computing device;
configure the second quantum computing device to forward a service request directed to the second QCS of the second quantum computing device to the first quantum computing device;
initialize a first QCS of the first quantum computing device using the QCS metadata;
receive the service request from the second quantum computing device; and
service, using the first QCS, the service request.

20. The non-transitory computer-readable medium of claim 19, wherein the first QCS and the second QCS comprise one of a qubit registry, a quantum task manager, or a quantum scheduler.
